(19) United States
(12) Patent Application Publication
(10) Pub. No.: US 2017/0215390 A1
(43) Pub. Date: Aug. 3, 2017

(54) Floatation Device for an Aquaculture Basket

(71) Applicant: Seapa Pty Ltd, Edwardstown (AU)

(72) Inventors: Alex Jack, Edwardstown (AU); Garry Thompson, Edwardstown (AU)

(21) Appl. No.: 15/204,382

(22) Filed: Jul. 7, 2016

(30) Foreign Application Priority Data
Jan. 29, 2016 (AU) 2016200539

(51) Int. Cl. A01K 61/00

(52) U.S. Cl. CPC A01K 61/002

(57) ABSTRACT

A catamaran-shaped floatation device wherein an oyster basket can be attached to the upside of the device for elevation of the oysters above the water level, and then inverted to submerge the oysters below the water level.

### CROSS-REFERENCE TO RELATED APPLICATION

This application claims priority to Australian Patent Application No. 2016200539 filed Jan. 29, 2016, the disclosure of which is hereby incorporated in its entirety by reference.

### FIELD OF THE INVENTION

The present invention relates to a floatation device for an aquaculture basket.

### BACKGROUND OF THE INVENTION

It is common for molluscs such as oysters to be grown on a commercial scale in artificial environments. Typically, the oysters are grown inside baskets that are suspended in the ocean and have perforated walls. The perforations enable water to flow through the baskets where the oysters use the water flow to obtain nutrients from the water as well as flushing impurities away.

The oyster baskets themselves are largely tubular mesh baskets that are fastened at least at either end and suspended above the ocean floor. In intertidal environments a single basket is typically hung in the water whilst in sub tidal environments it is known to hang a number of baskets vertically one above the other in a ladder arrangement.

The typical basket that is in use is an elongate and flattened tubular cross-section and is made of mesh material such as metal or plastic having ends caps fitted at either end of the basket. Sea water flows not only through the perforations in the basket wall but also the end caps. The contents of the basket are accessed by removing one or both of the end caps.

It is advantageous in oyster cultivation for the oysters to switch between a state wherein they are submerged under the water and a state wherein they are resting above or out of the water. In natural cultivation when the oysters are attached to the bed or reef this is achieved through the natural movement of the tides, meaning that the oysters will be constantly and regularly submerged in water when the tide is in, and unsubmerged when the tide is out. This changing of environment strengthens the oyster as it shifts between an open state and a resting (closed) state through the working of the oyster's adductor muscle. It also allows for the oysters to dry out there by killing off any over growth and fouling.

It is become increasingly common for oyster baskets to be used in farms where there is no significant tidal movement and therefore the oyster matures entirely submerged in the water. However this makes oysters more likely to die when harvested as it has not been cultivated shifting between an open and closed state to the extent of an oyster in its natural habitat. It is therefore advantageous of oyster baskets to be mounted on a flotation device which can be easily transported and the basket submerged in the water at regular intervals without greatly increasing farming costs.

The object of this invention is to provide a floatation device for an oyster basket that alleviates the above problems, or at least provides the public with a useful alternative.

### SUMMARY OF THE INVENTION

In a first aspect the invention comprises a floatation device for aquaculture farming comprising a catamaran shaped hull.

In preference, the device contains at least two brackets for attachment of an aquaculture basket.

In preference, the device contains at least one ring for attachment of a rope or other attachment means;

In preference, the device floats upon a body of water for the purposes of oyster farming.

In preference, the basket is attached to the upside of the device to float above the water line, and is adapted to be inverted to submerge the basket under the water.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 illustrates a perspective view of an oyster basket attached to a floatation device;

FIG. 2 illustrates a perspective view of the floatation device;

FIG. 3 illustrates a front view of the floatation device;

FIG. 4 illustrates a top view of the floatation device; and

FIG. 5 illustrates a side view of the floatation device.

### LIST OF COMPONENTS

10 oyster basket
20 floatation device
22 hull
24 brackets
26 end cap
28 rear brackets
30 front ring
32 rear ring

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

Turning now to the drawings there is illustrated an oyster basket 10 attached to a flotation device 20, wherein the flotation device is preferably a single piece of hollow moulded plastic forming a catamaran hull shape 22. The top side of the device 20 contains four brackets 24 to which the basket can be attached via engaging its end cap. The basket 10 can be attached to the brackets 24 through known means such as mating surfaces or a snap fit arrangement. It is to be understood that whilst reference is made to a catamaran shaped hull, the shape of the hull may indeed be varied according to the local conditions.

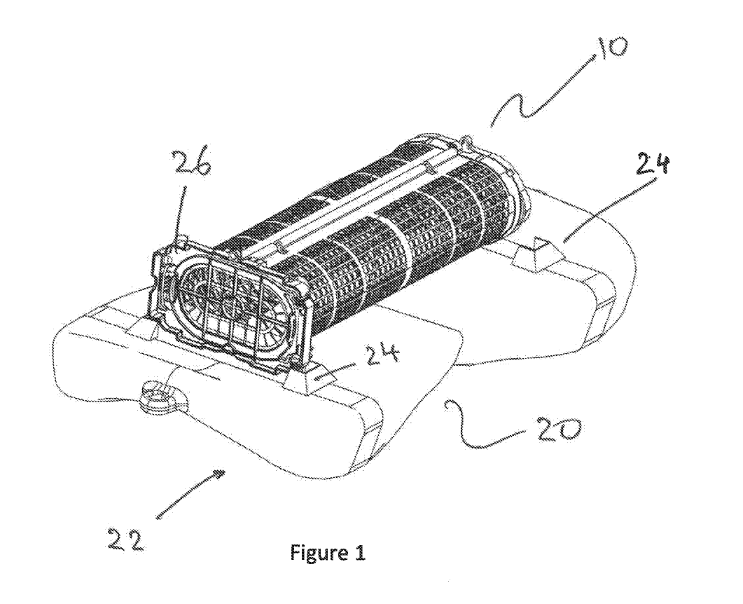

In FIG. 1 there is illustrated a single end cap 26 attached to the front two brackets 24, however it is to be understood that the invention is adapted for a second end cap to be attached to the rear two brackets 28 in the same manner The basket 10 can be secured via only one end attachment to save costs, however it is preferable for both ends to be attached for maximum security of the attachment.

The device 20 is of a larger footprint than the basket 10, therefore providing a stable and secure float, and the shape of the hull 22 is such that a relatively small amount of plastic is used thereby decreasing the overall cost of the device 20 while providing a stable structure which floats upon the water.

Thus when the floatation device 20 is in the upright position the oyster basket rests on the upside of the device and is therefore elevated out of the water. Inside the basket the oysters close their shells when in contact with the air, allowing them to dry out and additionally burning off and/or killing any overgrowth or fouling.

The device 20 can be inverted so that the topside of the device floats on the water and the basket is submerged underneath. This prompts the oysters to open their shells, working the adductor muscles and allowing the oysters to feed and grow. Therefore, the device 20 can be flipped at desired intervals to mimic the movement of the tides and exposing the oysters to alternatively submerged and dry environments which increases their health and life.

Therefore, the device 20 and oyster basket 10 can be used in non-intertidal environments such as oyster farms without any disadvantage over naturally cultivated oyster beds. In fact, the system can lead to increased and uniform growth rates, minimisation of labour, sustainability, avoidance of damage to natural reefs and oyster beds and reduced costs.

The shape of the hull 22 in particular is advantageous due to its catamaran shape which uses less surface area than a flat shape thus reducing production costs while still providing a secure and sturdy platform that will not be overturned by accident. The optimum shape that occupies the least surface area is a sphere, and the shape that occupies the most surface area is a rectangular prism or cube. Therefore, a float shaped like a sphere would use the least amount of plastic and the rectangular prism or cube the most, increasing overall production costs as plastics can be extensive. However a sphere or completely rounded shape would not provide sufficient stability for the oyster basket and so is not practicable. The catamaran shape is ideal as it uses less plastic than a rectangular prism or sphere, but still provides overall stability for the basket. Nevertheless as mentioned above other shapes may very well be employed.

The device 20 also contains a front ring 30 located at the front of the hull 22 and a rear ring 32 located at the rear of the hull 22. This allows the attachment or lines to the rings 30 and 32 for easy transport or use of a longline system joining many devices to one another.

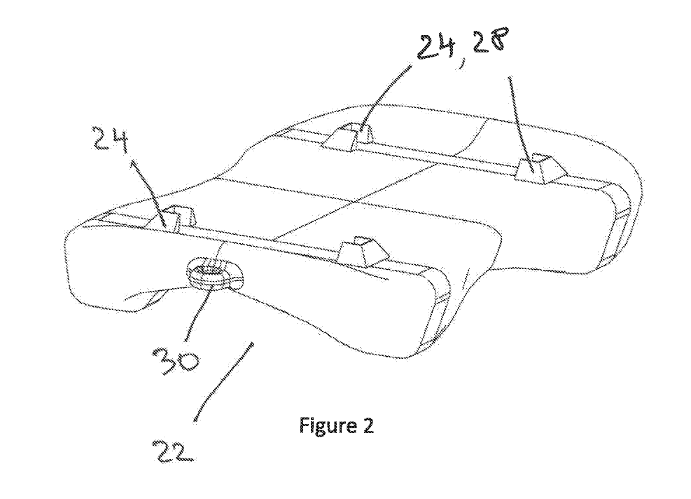

Illustrated in FIG. 2 is a perspective view of the device 20 without the oyster basket attached. In this Figure the features of the device can be seen more clearly including the placement of the front and rear brackets 24 and 28.

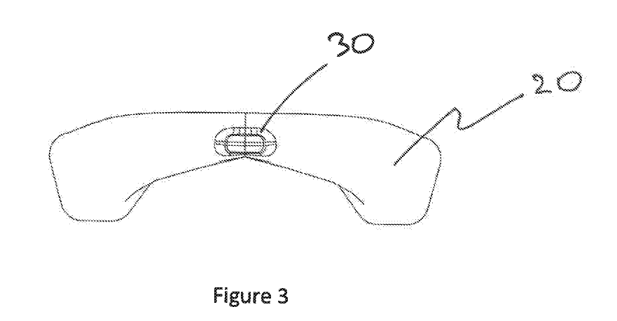

A front view of the device 20 is illustrated in FIG. 3 where the catamaran shape of the hull 22 can be seen more clearly. The upside of the device 20 is in preference primarily flat to allow for easy securement of the basket 10 and slightly curved on the sides and a concave arch formed on the underside of the hull 22. This prevents any water from splashing up into the basket 10 allowing the oysters to dry through contact with the open air. This shape also reduces water resistance when the device 20 is being pulled along by a rope or some other apparatus, allowing it to glide smoothly through the water like a boat.

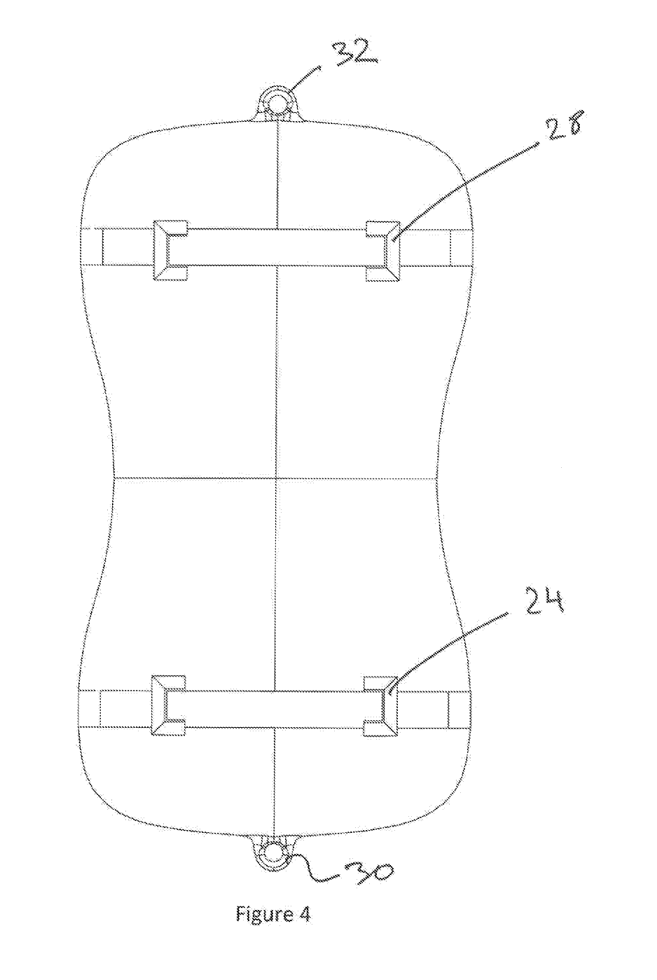

FIG. 4 illustrates a top view of the device 20 with the components of the upside, including the front brackets 24, rear brackets 28, front ring 30 and rear ring 32.

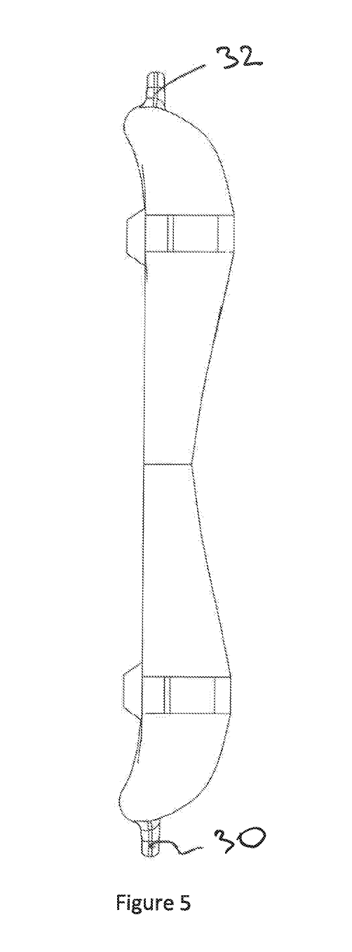

FIG. 5 illustrates a side view of the device demonstrating further the concave front and rear ends which distribute the buoyance of the device 20, thus increasing the solidity and durability of the device 20.

The reader will now appreciate the present invention which is a flotation device wherein an oyster basket can be attached to the upside of the device for elevation of the oysters above the water level, and then inverted to submerge the oysters below the water level, and wherein the shape of the device allows for maximum buoyance with reduced surface area. In an additional aspect of the invention the device contains rings which allow for easy transport of the device across the water, and wherein the catamaran shape of the hull allows for smooth transport.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

Thus it is to be understood that the floatation device could accommodate one more baskets in a stacked arrangement provided that the floatation device has sufficient buoyance. Other variations may include how the baskets are locked to the floatation device and the floatation device may include multiple attachment means to suit different types of baskets.

In the present specification and claims (if any), the word “comprising” and its derivatives including “comprises” and “comprise” include each of the stated integers but does not exclude the inclusion of one or more further integers.

1. A floatation device for aquaculture farming comprising a shaped hull.

2. The floatation device according to claim 1, wherein the device contains at least two brackets for attachment of an aquaculture basket.

3. The floatation device according to claim 1, wherein the device contains at least one ring for attachment of a rope or other attachment means.

4. The floatation device according to claim 1, wherein the device floats upon a body of water for the purposes of oyster farming.

5. The floatation device according to claim 2, wherein the device floats upon a body of water for the purposes of oyster farming.

6. The floatation device according to claim 3, wherein the device floats upon a body of water for the purposes of oyster farming.

7. The floatation device according to claim 1, wherein the basket is attached to the upside of the device to float above the water line, and can be inverted to submerge the basket under water.

8. The floatation device according to claim 2, wherein the basket is attached to the upside of the device to float above the water line, and can be inverted to submerge the basket under water.

9. The floatation device according to claim 3, wherein the basket is attached to the upside of the device to float above the water line, and can be inverted to submerge the basket under water.

10. The floatation device according to claim 4, wherein the basket is attached to the upside of the device to float above the water line, and can be inverted to submerge the basket under water.

11. The floatation device according to claim 5, wherein the basket is attached to the upside of the device to float above the water line, and can be inverted to submerge the basket under water.

12. The floatation device according to claim 6, wherein the basket is attached to the upside of the device to float above the water line, and can be inverted to submerge the basket under water.
